(19) United States
(12) Patent Application Publication
(10) Pub. No.: US 2022/0157075 A1
(43) Pub. Date: May 19, 2022

(54) TOUCH SCREEN AND DISPLAY DEVICE

(71) Applicant: WUHAN CHINA STAR OPTOELECTRONICS SEMICONDUCTOR DISPLAY TECHNOLOGY CO., LTD., Wuhan (CN)

(72) Inventors: Bo LI, Wuhan (CN); Qibing DAI, Wuhan (CN)

(21) Appl. No.: 17/054,303

(22) PCT Filed: Jun. 23, 2020
(86) PCT No.: PCT/CN2020/097813

§ 371 Date: Nov. 10, 2020

(30) Foreign Application Priority Data
May 6, 2020 (CN) 202010372469.3

(51) Int. Cl. G06V 40/13; G06F 3/044; G06F 3/041

(52) U.S. Cl. CPC G06V 40/1306; G06F 3/0412; G06F 3/0443

(57) ABSTRACT

A touch screen and a display device are provided. The touch screen includes a fingerprint area and a touch control area, wherein the fingerprint area is provided with a fingerprint recognition module, the touch control area is provided with a touch control module, and the fingerprint recognition module and the touch control module are disposed on a same layer. By disposing the touch control module and the fingerprint recognition module on the same layer, a fingerprint recognition function and a touch control function can be integrally realized. Compared with conventional fingerprint recognition devices, the present disclosure omits a process of attaching the fingerprint recognition module. Therefore, manufacturing costs of products are reduced, thicknesses of the products are reduced, and quality and function of the products are effectively improved.

### FIELD

The present disclosure relates to the field of display technologies, and more particularly, relates to a touch screen and a display device.

### BACKGROUND

Touch screens have been widely used in many devices, such as mobile phones, personal computers, and time attendance machines, due to merits of fast response times, high positioning accuracy, capability of supporting multi-touch, and long service life.

Fingerprint recognition technologies have been widely used due to good security and ease of use, but most current fingerprint recognition devices work individually.

The fingerprint recognition technologies are the most used in mobile phones. Nowadays, fingerprint recognition modules in the mobile phones include following types:

1. An individual button at a front side: such design makes the mobile phones easy to operate for users, but reduces a screen-to-body ratio of the mobile phones.

2. An individual button at a backside: such design makes a position of the button hidden from users' sight, so the users need to search for the button at the backside of the mobile phones with their fingers, which affects user experience.

3. A fingerprint recognition under a screen: such design has been on the rise in recent years; however, current under-screen fingerprint recognition technologies in market are realized by attaching an optical fingerprint module or an ultrasonic fingerprint module to a bottom side of the screen. As shown in FIG. 1, a touch screen includes a fingerprint recognition module 101, a touch control module 102, and a cover plate 103. The touch screen is very easy to operate for users as well as has a high screen-to-body ratio to realize a full-screen display. Nonetheless, due to the attached fingerprint module, a panel module at a front side of the mobile phones is thickened, which not only affects a design of an entire structure, but also increases manufacturing costs of products.

### SUMMARY

An objective of the present disclosure is to provide a touch screen and a display device to solve a following problem: a touch screen of conventional under-screen fingerprint recognition modules is thick, which not only affects a design of an entire structure, but also increases manufacturing costs of products.

To achieve the above goal, the present disclosure provides a touch screen, including a fingerprint area and a touch control area. The fingerprint area is provided with a fingerprint recognition module, the touch control area is provided with a touch control module, and the fingerprint recognition module and the touch control module are disposed on a same layer.

Furthermore, the touch screen includes a metal layer, an insulating layer, and a transparent conductive layer. The metal layer is distributed in the fingerprint area and the touch control area and includes a plurality of first metal lines and a plurality of second metal lines perpendicular to the first metal lines. The insulating layer is disposed on the metal layer in the fingerprint area and the touch control area. The transparent conductive layer disposed on the insulating layer and includes a plurality of first transparent electrodes and a plurality of second transparent electrodes perpendicular to the first transparent electrode.

In the fingerprint area, the first transparent electrodes are a plurality of fingerprint sensing electrodes of the fingerprint recognition module, the second transparent electrodes are a plurality of fingerprint driving electrodes of the fingerprint recognition module, and the fingerprint driving electrodes pass through the insulating layer to connect to the metal layer.

In the touch control area, the first metal lines are a plurality of touch control sensing electrodes of the touch control module, the second metal lines are a plurality of touch control driving electrodes of the touch control module, and the touch control driving electrodes pass through the insulating layer to connect to the transparent conductive layer.

Furthermore, the fingerprint area includes: a plurality of first through-holes defined at a plurality of positions on the insulating layer corresponding to the first metal lines; a plurality of second through-holes defined at a plurality of positions on the insulating layer corresponding to the second metal lines; and a plurality of third through-holes and a plurality of fourth-through holes defined at a plurality of positions on the transparent conductive layer corresponding to the second metal lines. The fingerprint driving electrodes are filled in the first through-holes and the second through-holes and cover the insulating layer between the first through-holes and the second through-holes.

Furthermore, the touch control area includes: a plurality of fifth through-holes and a plurality of sixth through-holes defined at a plurality of positions on the insulating layer corresponding to the first metal lines; and a plurality of virtual units disposed at a plurality of positions on the transparent conductive layer corresponding to the first metal lines. The transparent conductive layer is filled in the fifth through-holes and the sixth through-holes and covers the insulating layer between the fifth through-holes and the sixth through-holes.

Furthermore, the transparent conductive layer includes: a plurality of fingerprint sensing electrode areas; a plurality of first connecting areas, wherein two adjacent fingerprint sensing electrode areas are connected to each other by the first connecting areas; a plurality of fingerprint driving electrode areas defined on a same layer as the fingerprint sensing electrode areas; and a plurality of second connecting areas alternately arranged with the first connecting areas, wherein two adjacent fingerprint driving electrode areas are connected to each other by the second connecting areas.

Furthermore, the metal layer includes: a plurality of touch control sensing electrode areas; a plurality of third connecting areas, wherein two adjacent touch control sensing electrode areas are connected to each other by the third connecting areas; a plurality of touch control driving electrode areas defined on a same layer as the touch control sensing electrode areas; and a plurality of fourth connecting areas alternately arranged with the third connecting areas, wherein two adjacent touch control driving electrode areas are connected to each other by the fourth connecting areas.

Furthermore, the touch screen further includes: a substrate; a thin-film transistor (TFT) layer disposed on the substrate; a luminescent layer disposed on the TFT layer; and a thin-film encapsulation layer disposed on the luminescent layer. The metal layer is disposed on the thin-film encapsulation layer.

Furthermore, the luminescent layer is provided with a plurality of sub-pixels, and one of the virtual units covers one of the sub-pixels in the touch control area.

Furthermore, the metal layer includes a composite structure including a Ti layer and an Al layer which are stacked, and the transparent conductive layer includes a composite structure including an indium tin oxide (ITO) layer and an Ag layer which are stacked.

To achieve the above goal, the present disclosure further provides a display device including the above-mentioned touch screen.

Regarding the beneficial effects: the present disclosure provides a touch screen and a display device. By disposing a touch control module and a fingerprint recognition module on a same layer, a fingerprint recognition function and a touch control function can be integrally realized. Compared with conventional fingerprint recognition devices, the present disclosure omits a process of attaching the fingerprint recognition module. Therefore, manufacturing costs of products are reduced, thicknesses of the products are reduced, and quality and function of the products are effectively improved.

Moreover, a transparent conductive layer and a metal layer are connected to each other in a fingerprint area, so that signals thereof can be connected. A portion of the metal layer becomes a bridge structure to connect adjacent transparent electrodes, thereby forming multiple fingerprint driving electrodes arranged along a direction. A special structural design of the metal layer combined with the transparent conductive layer can effectively reduce electrical resistance in a channel and boost a sensing signal strength. By disposing multiple virtual units in a touch control area, structures of the touch control area and the fingerprint area can be consistent, and optical properties of the touch control area and the fingerprint area can be consistent as well. As a result, each position of the touch screen can have same optical effects, and an optical effect of the entire touch screen can be ensured.

### DESCRIPTION OF DRAWINGS

Technical solutions and beneficial effects of the present disclosure are illustrated below in detail in conjunction with drawings and specific embodiments.

FIG. 1 is a structural schematic view showing a conventional touch screen.

FIG. 2 is a structural schematic view showing a touch screen according to an embodiment of the present disclosure.

FIG. 3 is a structural schematic view showing a fingerprint recognition module according to the embodiment of the present disclosure.

FIG. 4 is a structural schematic view showing a touch control module according to the embodiment of the present disclosure.

FIG. 5 is a top view showing a fingerprint area according to the embodiment of the present disclosure.

FIG. 6 is a top view showing a touch control area according to the embodiment of the present disclosure.

FIG. 7 is an enlarged view showing a unit A in FIG. 6.

FIG. 8 is an enlarged view showing a unit B in FIG. 5

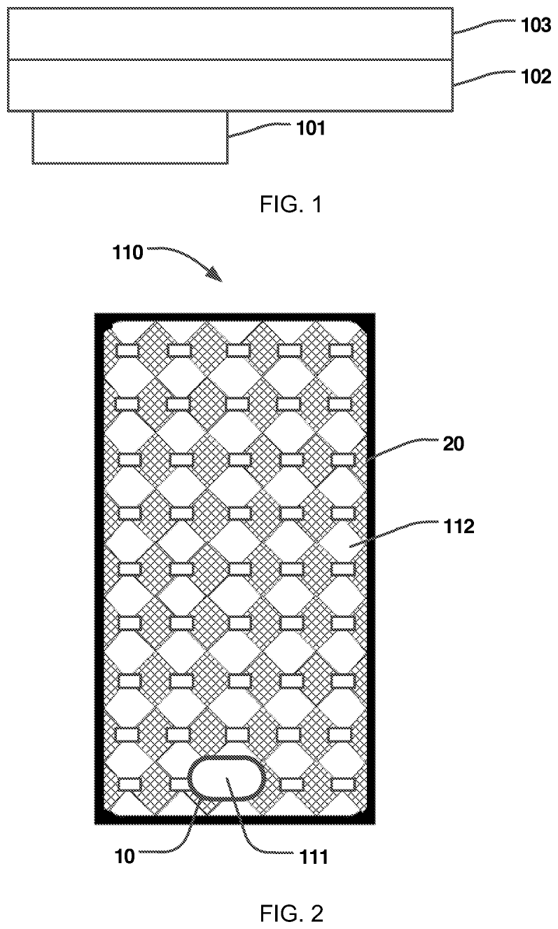

### DETAILED DESCRIPTION

A preferred embodiment of the present disclosure is illustrated below with reference to accompanying drawings to prove that the present disclosure can be implemented. The embodiment is used to fully describe technical solutions of the present disclosure so that those skilled in the art may clearly and easily understand the technical solutions. The present disclosure may be realized by many different types of embodiments; therefore, the scope of protection of the present disclosure is not limited to the embodiment mentioned in the specification.

An embodiment of the present disclosure provides a display device, including a touch screen. The display device may be a mobile phone, a computer, a television, or a smart wearable device, but is not limited thereto in the present embodiment.

As shown in FIG. 2, the present embodiment provides a touch screen 110, including a fingerprint area 111 and a touch control area 112. The fingerprint area 111 is provided with a fingerprint recognition module 10, the touch control area 112 is provided with a touch control module 20, and the fingerprint recognition module 20 and the touch control module 10 are disposed on a same layer. The fingerprint area 111 is used to recognize user's fingerprint to unlock the display device, and the touch control area 112 is used to realize a touch control function of the display device.

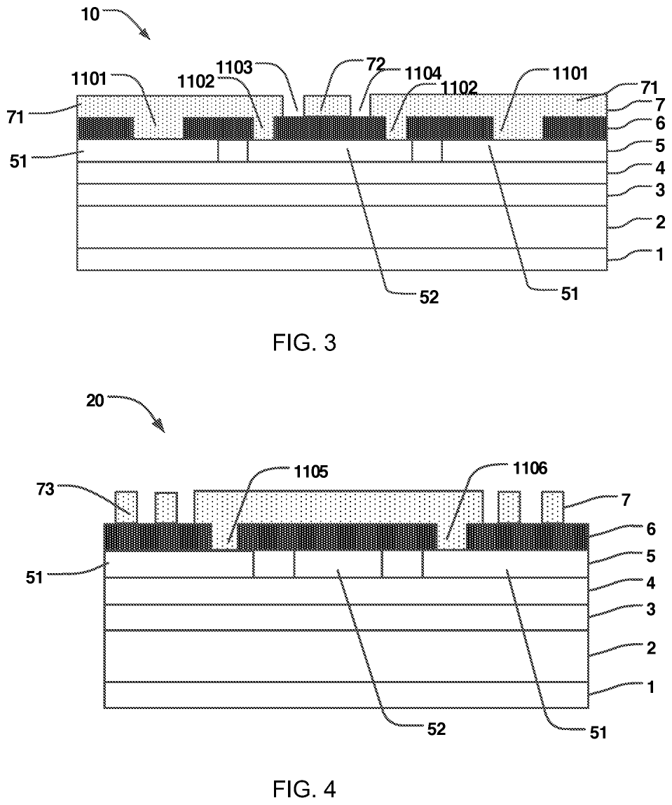

As shown in FIG. 3 to FIG. 4, the touch screen 110 sequentially includes a substrate 1, a thin-film transistor (TFT) layer 2, a luminescent layer 3, a thin-film encapsulation layer 4, a metal layer 5, an insulating layer 6, and a transparent conductive layer 7 from bottom to top.

The substrate 1 is a typical glass substrate. The TFT layer 2 includes a plurality of TFTs configured to drive the touch screen 110 to work. The luminescent layer 3 includes a luminescent material and is used to emit light to make the touch screen 110 able to display. The thin-film encapsulation layer 4 is used to protect the luminescent layer 3, thereby preventing ambient moisture and oxygen from entering the touch screen 110 and damaging a luminescence driving circuit.

The metal layer 5 is distributed in the fingerprint area 111 and the touch control area 112, and is patterned. The metal layer 5 includes a plurality of first metal lines 51 and a plurality of second metal lines 52 perpendicular to the first metal lines 51. The metal layer 5 includes a composite structure including a Ti layer and an Al layer which are stacked, so that it has improved conductivity.

The insulating layer 6 is patterned and is disposed on the metal layer 5 in the fingerprint area 111 and the touch control area 112.

The transparent conductive layer 7 is disposed on the insulating layer 6 and includes a plurality of first transparent electrodes 71 arranged along a first direction and a plurality of second transparent electrodes 72 along a second direction perpendicular to the first direction. The transparent conductive layer 7 includes a composite structure including an indium tin oxide (ITO) layer and an Ag layer which are stacked.

As shown in FIG. 3, in the fingerprint area 111, the first transparent electrodes 71 are fingerprint sensing electrodes of the fingerprint recognition module 10, the second transparent electrodes 72 are fingerprint driving electrodes of the fingerprint recognition module 10, and the fingerprint driving electrodes pass through the insulating layer to connect to the metal layer 5. The fingerprint sensing electrodes and the fingerprint driving electrodes form a mutual-capacitive device. The fingerprint driving electrodes output a driving signal in the second direction, and the fingerprint sensing electrodes output a sensing signal along the first direction, thereby realizing mutual-capacitive sensing.

Specifically, the fingerprint area 111 includes a plurality of first through-holes 1101, a plurality of second through-holes 1102, a plurality of third through-holes 1103, and a plurality of fourth through-holes 1104.

The first through-holes 1101 are defined on a plurality of positions on the insulating layer 6 corresponding to the first metal lines 51. The second through-holes 1102 are defined on a plurality of positions on the insulating layer 6 corresponding to the second metal lines 52. The fingerprint driving electrodes are filled in the first through-holes 1101 and the second through-holes 1102 and cover the insulating layer between the first through-holes 1101 and the second through-holes 1102.

In the present embodiment, the first transparent electrodes 71 pass through the second through holes 1102 to connect to the second metal lines 52, thereby forming a plurality of first electrical bridges and connecting signals of the first metal line 5 and the transparent conductive layer 7. In other words, two adjacent first transparent electrodes 71 are connected to each other by a bridge structure formed from the second metal lines 52, thereby forming the first electrical bridges. The first electrical bridges constitute the fingerprint driving electrodes arranged along the second direction in the fingerprint area 111, thereby transmitting signals in the fingerprint area 111. Therefore, electrical resistance of the fingerprint driving electrodes in the second direction is effectively reduced, an amount of voltage loss is reduced, and a sensing signal strength is improved. Wherein, the second metal lines 52 are bridge structures of the first electrical bridges.

The third through-hole 1103 and the fourth through-hole 1104 are defined at positions on the transparent conductive layer 7 corresponding to the second metal lines 52, thereby dividing into the first transparent electrodes 71 and the second transparent electrodes 72. Specifically, in practical processes, the transparent conductive layer 7 is patterned to form the first transparent electrodes 71 and the second transparent electrodes 72. The third through-holes 1103 and the fourth through-holes 1104 are defined at two sides of the second transparent electrodes 72, thereby insulating the first transparent electrodes 71 from the second transparent electrodes 72.

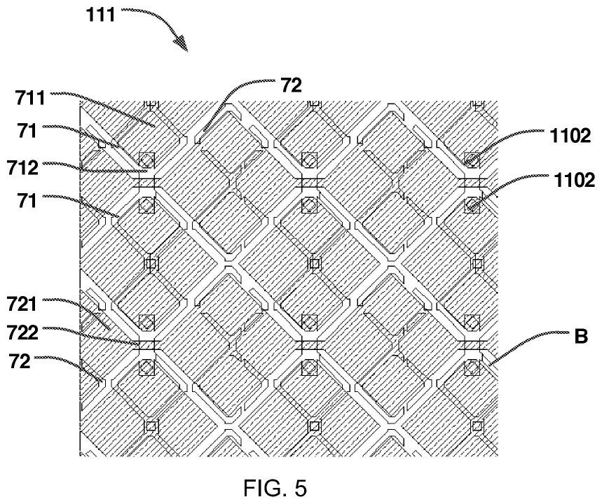

As shown in FIG. 3 and FIG. 5, the transparent conductive layer 7 includes a plurality of fingerprint sensing electrode areas 711 and a plurality of first connecting areas 712, which are arranged along the first direction, and a plurality of fingerprint driving electrode areas 721 and a plurality of second connecting areas 722, which are arranged along the second direction.

As shown in FIG. 5, the fingerprint area 111 has a metal grid structure. The fingerprint driving electrode areas 721 and the fingerprint sensing electrode areas 711 are disposed on a same layer, and two adjacent fingerprint sensing electrode areas 711 are electrically connected to each other by the first connecting areas 712. The second connecting areas 722 and the first connecting areas 712 are alternately disposed, and two adjacent fingerprint driving electrode areas 721 are electrically connected to each other by the second connecting areas 722.

As shown in FIG. 4, in the touch control area 112, the first metal lines 51 are touch control sensing electrodes of the touch control module 20, the second metal lines 52 are touch control driving electrodes of the touch control module 20, and the touch control driving electrodes pass through the insulating layer to connect to the transparent conductive layer. The touch control sensing electrodes and the touch control driving electrodes form a mutual-capacitive device. The touch control driving electrodes output a driving signal in the second direction, and the touch control sensing electrodes output a sensing signal along the first direction, thereby realizing mutual-capacitive sensing.

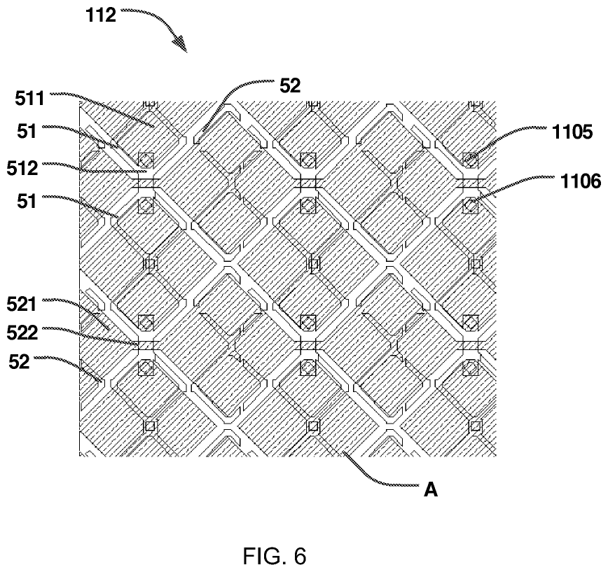

As shown in FIG. 4 and FIG. 6, in the touch control area 112, a plurality of fifth through-holes 1105 and a plurality of sixth through-holes 1106 are defined at a plurality of positions on the insulating layer 6 corresponding to the first metal lines 51.

The transparent conductive layer 7 is filled in the fifth through-holes 1105 and the sixth through-holes 1106 and covers the insulating layer 6 between the fifth through-holes 1105 and the sixth through-holes 1106, thereby forming a plurality of second electrical bridges. In other words, the transparent conductive layer 7 covering the insulating layer 6 between the fifth through-holes 1105 and the six through-holes 1106 is a bridge structure that connects two adjacent touch control driving electrodes to each other to form the second electrical bridges. The second electrical bridges are connected to each other to constitute the touch control driving electrodes arranged along the first direction in the touch control area 112, thereby transmitting signals in the touch control area 112.

As shown in FIG. 6, the touch control area 112 has a metal grid structure. The metal layer 5 includes a plurality of touch control sensing electrode areas 511, a plurality of third connecting areas 512, a plurality of touch control driving electrode areas 521, and a plurality of fourth connecting areas 522.

The touch control sensing electrode areas 511 and the touch control driving electrode areas 521 are defined on a same layer, and two adjacent touch control sensing electrode areas 511 are connected to each other by the third connecting areas 512. The fourth connecting areas 522 and the third connecting areas 512 are alternately disposed, and two adjacent touch control driving electrode areas 521 are electrically connected to each other by the fourth connecting areas 522.

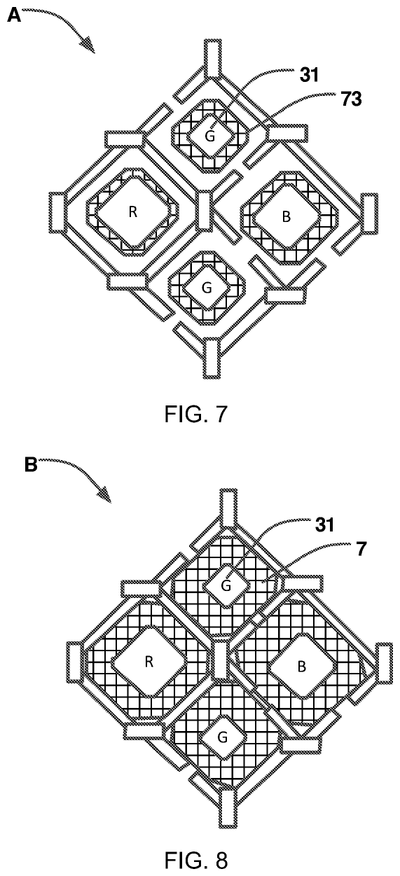

As shown in FIG. 7 to FIG. 8, the luminescent layer includes a plurality of sub-pixels 31 including a red sub-pixel, a green sub-pixel, and a blue sub-pixel. In the touch control area, four adjacent sub-pixels constitute a unit A. In the fingerprint area, four adjacent sub-pixels constitute a unit B.

In the touch control area 112, a plurality of isolated virtual units 73 are disposed at a plurality of positions on the transparent conductive layer 7 corresponding to the first metal lines 51. Adjacent virtual units 73 are not electrically connected to each other, as shown in FIG. 4. Each of the virtual units 73 covers one of the sub-pixels 31, a pattern of the virtual units 73 is larger than a corresponding pattern the sub-pixels 31, as shown in FIG. 7.

In the present embodiment, a top view of the touch screen 110 shows a metal grid structure which is formed of a plurality of tiny grids arranged in an array manner. An opening size of each of the sub-pixels 31 is less than a size of each of the grids, thereby ensuring consistency of light emitted from the sub-pixels 31, luminescent effects of the sub-pixels, and an entire display effect of the touch screen. In the fingerprint area 111, the transparent conductive layer 7 completely covers each of the tiny grids, and the sub-pixels 31 corresponding to the grids are covered by the transparent conductive layer 7, as shown in FIG. 8. In summary, by disposing multiple virtual units in the touch control layer, structures of the touch control area and the fingerprint area can be consistent, and optical properties of the touch control area and the fingerprint area can be consistent as well. As a result, each position of the touch screen can have same optical effects, and an optical effect of the entire touch screen can be ensured.

The present embodiment provides a touch screen and a display device. By disposing a touch control module and a fingerprint recognition module on a same layer, a fingerprint recognition function and a touch control function can be integrally realized. Compared with conventional fingerprint recognition devices, the present disclosure omits a process of attaching the fingerprint recognition module. Therefore, manufacturing costs of products are reduced, thicknesses of the products are reduced, and quality and function of the products are effectively improved.

Moreover, a transparent conductive layer and a metal layer are connected to each other in a fingerprint area, so that signals thereof can be connected. A portion of the metal layer becomes a bridge structure to connect adjacent transparent electrodes, thereby forming multiple fingerprint driving electrodes arranged along a direction. A special structural design of the metal layer combined with the transparent conductive layer can effectively reduce electrical resistance in a channel and boost a sensing signal strength. By disposing multiple virtual units in a touch control area, structures of the touch control area and the fingerprint area can be consistent, and optical properties of the touch control area and the fingerprint area can be consistent as well. As a result, each position of the touch screen can have same optical effects, and an optical effect of the entire touch screen can be ensured.

The above is merely a preferred embodiment of the present disclosure. It is understood that many changes and modifications to the described embodiment can be carried out without departing from the scope and the spirit of the disclosure that is intended to be limited only by the appended claims.

What is claimed is:

1. A touch screen, comprising a fingerprint area and a touch control area, wherein the fingerprint area is provided with a fingerprint recognition module, the touch control area is provided with a touch control module, and the fingerprint recognition module and the touch control module are disposed on a same layer.

2. The touch screen of claim 1, further comprising:
a metal layer distributed in the fingerprint area and the touch control area, wherein the metal layer comprises a plurality of first metal lines and a plurality of second metal lines perpendicular to the first metal lines;
an insulating layer disposed on the metal layer in the fingerprint area and the touch control area; and
a transparent conductive layer disposed on the insulating layer, wherein the transparent conductive layer comprises a plurality of first transparent electrodes and a plurality of second transparent electrodes perpendicular to the first transparent electrodes;
wherein in the fingerprint area, the first transparent electrodes are a plurality of fingerprint sensing electrodes of the fingerprint recognition module, the second transparent electrodes are a plurality of fingerprint driving electrodes of the fingerprint recognition module, and the fingerprint driving electrodes pass through the insulating layer to connect to the metal layer; and
in the touch control area, the first metal lines are a plurality of touch control sensing electrodes of the touch control module, the second metal lines are a plurality of touch control driving electrodes of the touch control module, and the touch control driving electrodes pass through the insulating layer to connect to the transparent conductive layer.

3. The touch screen of claim 2, wherein the fingerprint area comprises:
a plurality of first through-holes defined at a plurality of positions on the insulating layer corresponding to the first metal lines;
a plurality of second through-holes defined at a plurality of positions on the insulating layer corresponding to the second metal lines; and
a plurality of third through-holes and a plurality of fourth-through holes defined at a plurality of positions on the transparent conductive layer corresponding to the second metal lines;
wherein the fingerprint driving electrodes are filled in the first through-holes and the second through-holes and cover the insulating layer between the first through-holes and the second through-holes.

4. The touch screen of claim 2, wherein the touch control area comprises:
a plurality of fifth through-holes and a plurality of sixth through-holes defined at a plurality of positions on the insulating layer corresponding to the first metal lines; and
a plurality of virtual units disposed at a plurality of positions on the transparent conductive layer corresponding to the first metal lines;
wherein the transparent conductive layer is filled in the fifth through-holes and the sixth through-holes and covers the insulating layer between the fifth through-holes and the sixth through-holes.

5. The touch screen of claim 2, wherein the transparent conductive layer comprises:
a plurality of fingerprint sensing electrode areas;
a plurality of first connecting areas, wherein two adjacent fingerprint sensing electrode areas are connected to each other by the first connecting areas;
a plurality of fingerprint driving electrode areas defined on a same layer as the fingerprint sensing electrode areas; and
a plurality of second connecting areas alternately arranged with the first connecting areas, wherein two adjacent fingerprint driving electrode areas are connected to each other by the second connecting areas.

6. The touch screen of claim 2, wherein the metal layer comprises:
a plurality of touch control sensing electrode areas;
a plurality of third connecting areas, wherein two adjacent touch control sensing electrode areas are connected to each other by the third connecting areas;
a plurality of touch control driving electrode areas defined on a same layer as the touch control sensing electrode areas; and
a plurality of fourth connecting areas alternately arranged with the third connecting areas, wherein two adjacent touch control driving electrode areas are connected to each other by the fourth connecting areas.

7. The touch screen of claim 2, further comprising:
a substrate;
a thin-film transistor (TFT) layer disposed on the substrate;
a luminescent layer disposed on the TFT layer; and
a thin-film encapsulation layer disposed on the luminescent layer;
wherein the metal layer is disposed on the thin-film encapsulation layer.

8. The touch screen of claim 7, wherein the luminescent layer is provided with a plurality of sub-pixels, and one of a plurality of virtual units covers one of the sub-pixels in the touch control area.

9. The touch screen of claim 2, wherein the metal layer comprises a composite structure comprising a Ti layer and an Al layer which are stacked; and
the transparent conductive layer comprises a composite structure comprising an indium tin oxide (ITO) layer and an Ag layer which are stacked.

10. A display device, comprising the touch screen of claim 1.
